(19) United States
(12) Patent Application Publication
(10) Pub. No.: US 2025/0273910 A1
(43) Pub. Date: Aug. 28, 2025

(54) Communication Connector

(71) Applicant: TE Connectivity Japan G. K., Kawasaki-shi (JP)

(72) Inventor: Kentaro Yoshimura, Kawasaki-shi (JP)

(73) Assignee: TE Connectivity Japan G. K., Kawasaki-shi (JP)

(21) Appl. No.: 19/063,488

(22) Filed: Feb. 26, 2025

(30) Foreign Application Priority Data
Feb. 28, 2024 (JP) 2024-028398

(51) Int. Cl. H01R 13/6581; H01R 13/6594

(52) U.S. Cl. CPC H01R 13/6581; H01R 13/6594

(57) ABSTRACT

A communication connector includes a housing, a first conducting portion, a second conducting portion, and a third conducting portion. The housing is composed of an electrically conductive material and receives a mating connector. The first conducting portion is retained in the housing and conductively connected to the housing. The first conducting portion is conductively connected to a shield member of the mating connector. The second conducting portion is provided on one side of the housing and is conductively connected to the housing. The third conducting portion is provided on another side of the housing and is conductively connected to the housing.

### CROSS-REFERENCE TO RELATED APPLICATION

This application claims the benefit of the filing date under 35 U.S.C. § 119(a)-(d) of Japanese Patent Application No. JP2024-028398, filed on Feb. 28, 2024.

### FIELD OF THE INVENTION

The present invention relates to a connector and, more particularly, to a communication connector.

### BACKGROUND OF THE INVENTION

Communication connectors are required to reduce the effect of electromagnetic noise on communication signals to ensure good communication characteristics. A communication connector, in one example, is mated with a mating connector while being connected to a circuit board accommodated inside an electrically conductive enclosure. A communication connector disclosed in Japanese Patent Application No. JP2023-102172A, for example, includes a contact molded body including two contacts, and a resin housing accommodating an electrically conductive tubular member. While reducing the effect of electronic noise, however, the structure of the communication connector should avoid being complicated.

### SUMMARY OF THE INVENTION

A communication connector includes a housing, a first conducting portion, a second conducting portion, and a third conducting portion. The housing is composed of an electrically conductive material and receives a mating connector. The first conducting portion is retained in the housing and conductively connected to the housing. The first conducting portion is conductively connected to a shield member of the mating connector. The second conducting portion is provided on one side of the housing and is conductively connected to the housing. The third conducting portion is provided on another side of the housing and is conductively connected to the housing.

### BRIEF DESCRIPTION OF DRAWINGS

The invention will now be described by way of example with reference to the accompanying figures, of which:

FIG. 1 is an isometric view of a communication connector and a mating connector according to an exemplary embodiment;

FIG. 2 is a cross-sectional view of the communication connector and the mating connector of FIG. 1 taken along line II-II of FIG. 1;

FIG. 3 is an isometric view of the communication connector of FIG. 1 with a ground piece detached therefrom;

FIG. 4 is an isometric view of the communication connector of FIG. 1;

FIG. 5 is a cross-sectional view of the communication connector of FIG. 1 taken along line V-V of FIG. 4;

FIG. 6 is an isometric view of a communication connector according to another exemplary embodiment;

FIG. 7 is a cross-sectional view of the communication connector of FIG. 6 taken along line VII-VII of FIG. 6;

FIG. 8 is an isometric view of a communication connector according to another exemplary embodiment;

FIG. 9 is a cross-sectional view of the communication connector of FIG. 8 taken along line IX-IX of FIG. 8;

FIG. 10A is an isometric view of a communication connector according to another exemplary embodiment;

FIG. 10B is a detail side view of a portion of the communication connector of FIG. 10A, taken along arrow (b) in FIG. 10A;

FIG. 10C is a detail sectional side view of the portion of the communication connector of FIG. 10B, taken along line (c)-(c) of FIG. 10B;

FIG. 11 is a cross-sectional view of the communication connector of FIG. 10A taken along line XI-XI of FIG. 10A; and

FIG. 12 is an isometric view of a communication connector according to another exemplary embodiment.

### DETAILED DESCRIPTION

A communication connector 1 according to each exemplary embodiment of the present invention will be described below with reference to the drawings. It should be noted that the term “connection” as used herein means electrical connection and mechanical connection.

It should be noted that, for descriptive convenience, as shown in each drawing, a mating direction of the communication connector 1 and a mating connector 100 is a first direction X, a direction orthogonal to the first direction X is a second direction Y, and a direction orthogonal to the second direction Y is a third direction Z. In addition, (F) indicates frontward in the first direction X, (B) indicates rearward in the first direction X, (R) indicates rightward in the second direction Y, (L) indicates leftward in the second direction Y, (U) indicates upward in the third direction Z, and (D) indicates downward in the third direction Z.

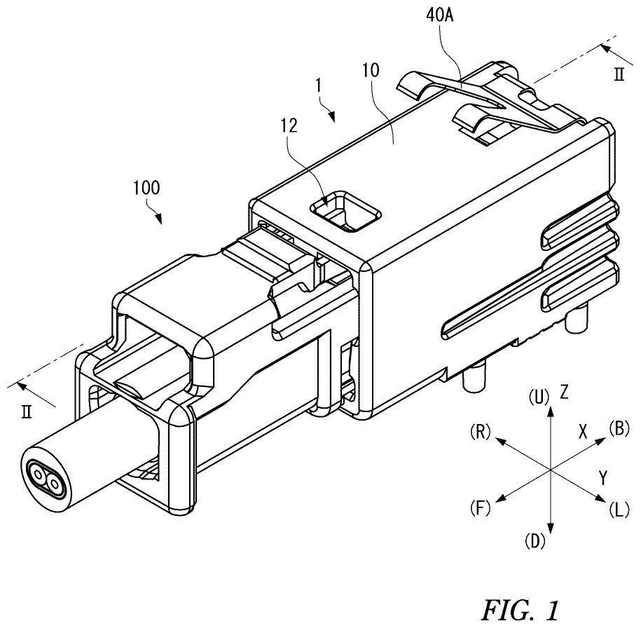

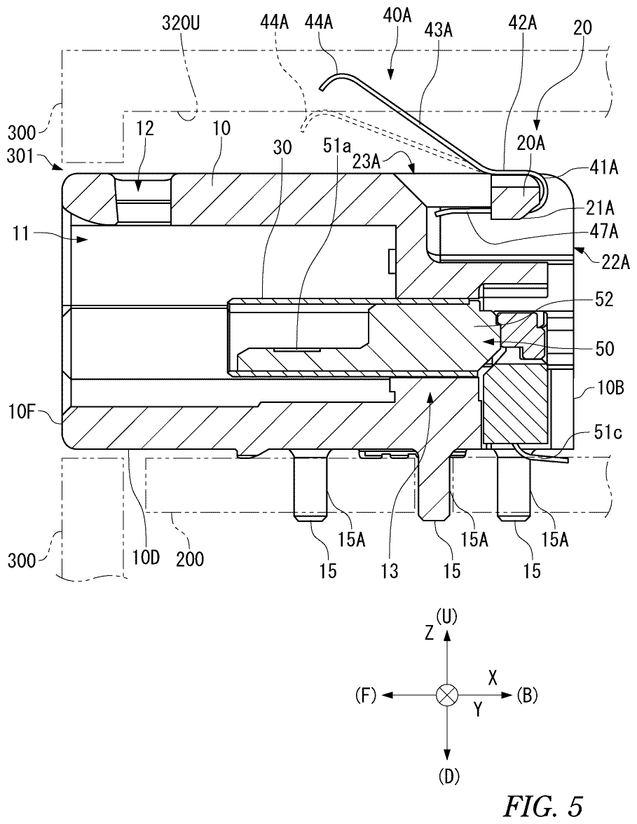

An exemplary embodiment of the communication connector 1 according to FIGS. 1-5 will now be described. As shown in FIG. 5, the communication connector 1 is mounted on a circuit board 200 installed inside an enclosure 300. The communication connector 1 is mated with a mating connector 100, as shown in FIGS. 1-3 and 5. As shown in FIG. 5, the communication connector 1 mated with the mating connector 100 is inserted through an opening portion 301 of the enclosure 300, thereby relaying communication signals from the mating connector 100 to the circuit board 200.

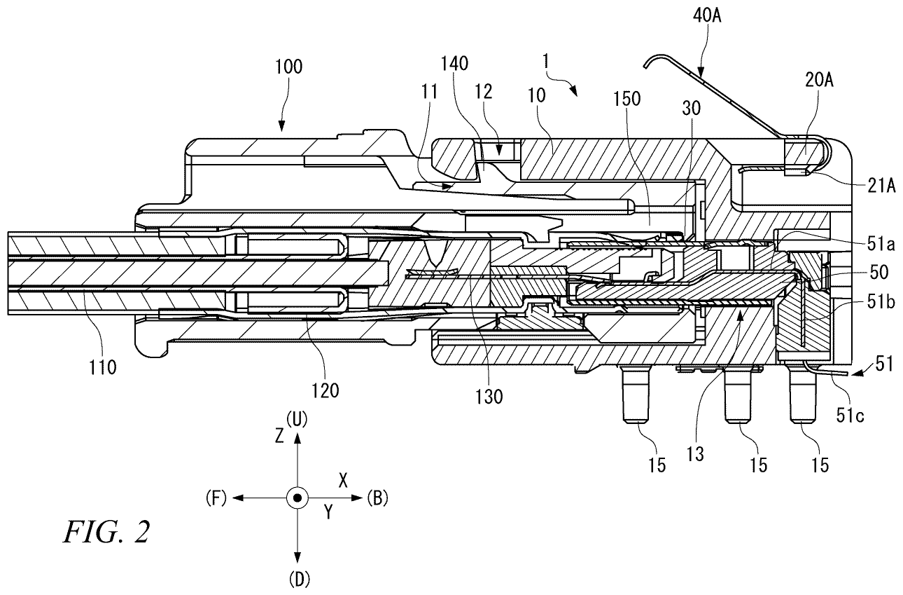

As shown in FIGS. 1-5, the communication connector 1 includes a housing 10. The housing 10 receives the mating connector 100, as shown in FIGS. 1-3 and 5, when the communication connector 1 and the mating connector 100 are mated. As shown in FIG. 2, the communication connector 1 also includes a tubular member 30 as a first conducting portion conductively connected to a shield member 110 of the mating connector 100. As shown in FIG. 5, the communication connector 1 also includes a ground piece 40A as a second conducting portion conductively connected to the enclosure 300. As shown in FIG. 2, the communication connector 1 also includes a contact molded body 50 provided with a contact portion 51 brought into contact with a contact portion 130 of the mating connector 100 to relay differential signals.

The housing 10 is formed with a mating opening 11, as shown in FIGS. 2 and 5, a catching hole 12, as shown in FIGS. 1-2, 4, and 5, a retaining portion 13, as shown in FIGS. 2 and 5, an attachment portion 20A, as shown in FIGS. 2 and 4-5, and a lead portion 15, as shown in FIGS. 2 and 4-5.

As shown in FIG. 2, a housing 150 of the mating connector 100 is inserted through the mating opening 11, and the catching hole 12 connects with the mating opening 11 and catches a catching portion 140 of the mating connector 100. The retaining portion 13 retains the tubular member 30 as the first conducting portion conductively connected to the shield member 110 of the mating connector 100, as shown in FIG. 2. The retaining portion 13 is conductively connected to the tubular member 30. As shown in FIG. 5, the attachment portion 20A elastically deforms, thereby pressing the enclosure 300. The ground piece 40A as the second conducting portion conductively connected to the enclosure 300 is attached to the attachment portion 20A, as shown in FIG. 5. As shown in FIG. 5, the lead portion 15 is a third conducting portion inserted into the circuit board 200. The tubular member 30 as the first conducting portion, the ground piece 40A as the second conducting portion, and the lead portion 15 as the third conducting portion are conductively connected to each other.

The housing 150 of the mating connector 100, at the time of mating with the mating connector 100, is inserted into the housing 10. The housing 10 thus receives the mating connector 100. As shown in FIG. 5, a front face 10F of the housing 10 in the first direction X receives the mating connector 100.

In the present embodiment, the housing 10 is composed of an electrically conductive material. For example, the housing 10 is composed of a die-cast member composed of an aluminum alloy.

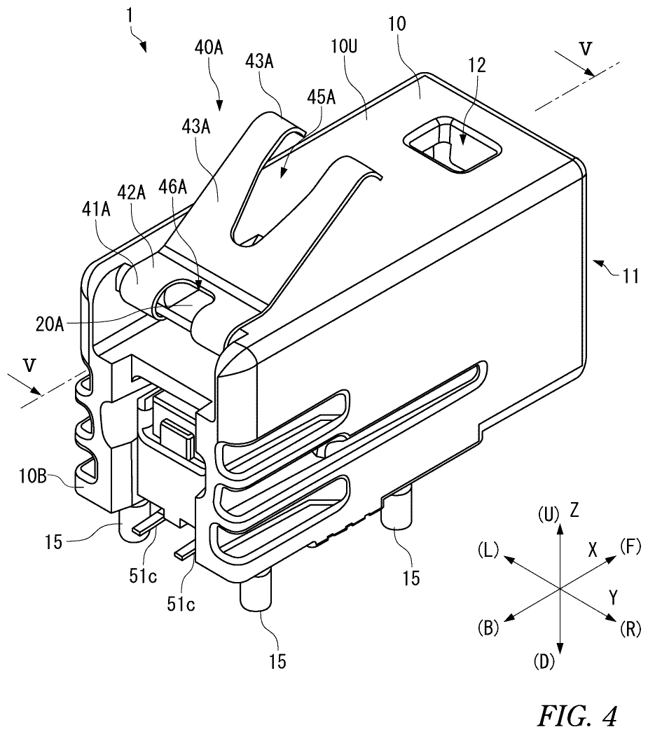

As shown in FIGS. 2 and 5, the mating opening 11 is formed at the front face 10F of the housing 10, through which the mating connector 100 is inserted. As shown in FIG. 4, the catching hole 12 is formed in an upper face 10U of the housing 10. The catching hole 12 connects with the mating opening 11, as shown in FIG. 5. As shown in FIG. 2, when the mating connector 100 is inserted through the mating opening 11, the catching portion 140 of the mating connector 100 is caught in the catching hole 12, thus preventing unexpected extraction of the mating connector 100.

As shown in FIGS. 2 and 5, the retaining portion 13 retains the tubular member 30. The retaining portion 13 is conductively connected to the tubular member 30 through a retained part of the tubular member 30.

As shown in FIG. 2, the contact molded body 50 is inserted into the tubular member 30. The tubular member 30 has the function of shielding an inserted portion of the contact molded body 50. As further shown in FIG. 2, the tubular member 30 is conductively connected to the shield member 110 on an outer peripheral face of the tubular member 30.

The contact molded body 50 is a component composed of the contact portion 51, and a resin body 52 integrally molded with the contact portion 51, as shown in FIG. 5. The contact portion 51 is composed of an electrically conductive member and, as shown in FIG. 2, has the function of coming into contact with a contact portion 130 of the mating connector 100 inserted through the mating opening 11 and relaying differential signals thereto. The contact portion 51 is bent in the middle to have a section extending in the first direction X and a section extending in the third direction Z.

As shown in FIG. 2, a section of the contact portion 51 extending in the frontward/rearward direction is referred to as a first contact section 51a, the section of the contact portion 51 extending in the third direction Z is referred to as a second contact section 51b, and a further section extending in the rearward direction B from a lower end of the second contact section 51b is referred to as a third contact section 51c. As shown in FIG. 5, the third contact section 51c is soldered to a contact portion of the circuit board 200 when the communication connector 1 is mounted on the circuit board 200. That is, the third contact section 51c is surface-mounted on the circuit board 200.

As shown in FIG. 4, the attachment portion 20A is formed in the upper face 10U at the rear of the housing 10. Specifically, as shown in FIGS. 4-5, an attachment opening 22A extending in the frontward direction F from a rear face 10B of the housing 10 is formed. As shown in FIG. 5, an insertion opening 23A connecting with the attachment opening 22A is formed in the upper face 10U of the housing 10. The attachment portion 20A is formed with a latch portion 21A, as shown in FIG. 5.

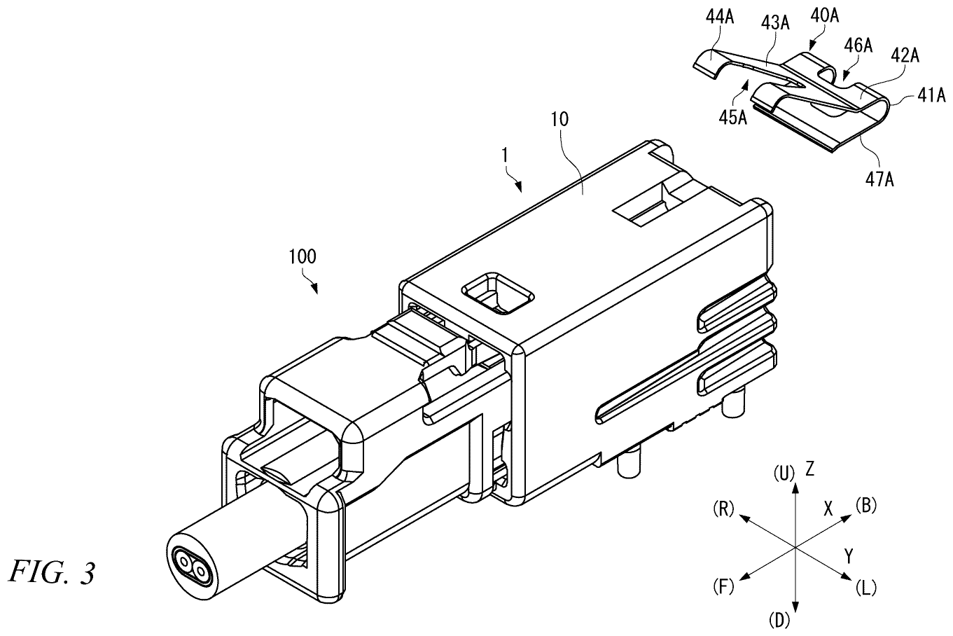

As shown in FIGS. 3 and 5, the ground piece 40A, in a side view, is formed in a U-shape 41A, and is formed with a shielding portion 43A extending from an upper section 42A of the U-shape 41A, and a curved portion 44A is formed on a distal end side of the shielding portion 43A. A lower section 47A of the U-shape 41A extends in the frontward direction F, and extends obliquely downward in the frontward direction F on a distal end side. In addition, the shielding portion 43A is formed with a notched portion 45A, as shown in FIGS. 3-4, thereby being divided into two branches. In addition, an opening 46A is formed in a middle section of the U-shape 41A. As shown in FIGS. 2 and 4-5, when the ground piece 40A is attached to the attachment portion 20A, the latch portion 21A of the attachment portion 20A enters the opening 46A to prevent unexpected extraction of the ground piece 40A. The ground piece 40A has a function as a flat spring for pressing the enclosure 300 with the curved portion 44A by elastic deformation of a portion connecting from the upper section 42A to the shielding portion 43A and of the shielding portion 43A.

As shown in FIGS. 2 and 4-5, the lead portion 15 extends in the downward direction D from a lower face of the housing 10. The lead portion 15 has a cylindrical shape, and includes five lead portions 15 formed on the housing 10. When the communication connector 1 is mounted on the circuit board 200, the lead portion 15 serves as a mount portion 15A inserted into the circuit board 200 and further soldered thereto, and is conductively connected to the circuit board 200. That is, after being inserted into the circuit board 200, the cylindrical lead portion 15 is through-hole mounted and firmly secured.

As shown in FIG. 5, each of the five lead portions 15 and the circuit board 200 are conductively connected to each other, thereby increasing the number of electric current paths for grounding. By forming a plurality of grounded electric current paths, the number of paths for releasing electric current that will cause noise to a portion where communication signals are not affected can be increased, and the occurrence of noise can be reduced. In addition, by forming the grounded electric current paths between the lead portions 15 and the circuit board 200, an electric current conduction distance is shortened, and the occurrence of noise can be reduced.

As shown in FIG. 5, the communication connector 1 is mounted on the circuit board 200 incorporated in the enclosure 300. When the communication connector 1, having the third contact section 51c conductively connected to the contact portion of the circuit board 200, is mated with the mating connector 100, the contact portion 130 of the mating connector 100 and the first contact section 51a, as shown in FIG. 2, are brought into contact with each other, relaying signals send from the mating connector 100 to the circuit board 200.

When the communication connector 1, having the lead portion 15 conductively connected to a through-hole portion of the circuit board 200, is mated with the mating connector 100, the shield member 110 of the mating connector 100 and the tubular member 30 are conductively connected to each other. In addition, since the tubular member 30 and the retaining portion 13 retaining the tubular member 30 are conductively connected to each other, and the retaining portion 13, composed of an aluminum alloy, and the lead portion 15 are conductively connected to each other, the ground potentials of the mating connector 100 and the communication connector 1 are kept at the same ground potential as the circuit board 200.

The communication connector 1 is conductively connected to the enclosure 300 by pressing the ground piece 40A against the enclosure 300. Each of the two branches of the shielding portion 43A of the ground piece 40A and the enclosure 300 are conductively connected to each other, and thereby a plurality of grounded electric current paths can be formed. By forming a plurality of grounded electric current paths, the number of paths for releasing electric current that will cause noise to a portion where communication signals are not affected can be increased, and the occurrence of noise can be reduced.

When the communication connector 1, having the lead portion 15 conductively connected to the through-hole portion of the circuit board 200, is mated with the mating connector 100, the shield member 110 of the mating connector 100 and the tubular member 30 are conductively connected to each other. In addition, the tubular member 30 and the retaining portion 13 retaining the tubular member 30 are conductively connected to each other, and the retaining portion 13, composed of an aluminum alloy, and the attachment portion 20A are conductively connected to each other. Since the attachment portion 20A and the ground piece 40A are conductively connected to each other, the ground potentials of the mating connector 100 and the communication connector 1 are kept at the same ground potential as the enclosure 300.

By arranging the ground piece 40A between the housing 10 and the enclosure 300, in a projected part of the ground piece 40A when the housing 10 is viewed from the front, the advance of radiation noise entering through the opening portion 301 between the housing 10 and the enclosure 300 can be shielded. This can reduce the effect of the radiation noise on the communication connector 1 and the circuit board 200. It should be noted that “when the housing 10 is viewed from the front” refers to a view in the first direction X where the housing 10 is viewed from the front from the rear in the first direction X.

In the present embodiment, the lead portion 15 serves as a mount portion 15A through-hole mounted on the circuit board 200, but the lead portion 15 is not limited to this. For example, like the third contact section 51c, the lead portion 15 may be a mount portion surface-mounted on a contact portion of the circuit board 200.

Advantageous effects of the communication connector 1 according to FIGS. 1-5 will now be described.

The communication connector 1 of the present embodiment includes the housing 10 composed of an electrically conductive material, the tubular member 30 as the first conducting portion that is retained while being conductively connected to the housing 10, and that is conductively connected to the shield member 110 of the mating connector 100, the ground piece 40A as the second conducting portion that is provided on the upper face 10U as one face side of the housing 10, and that is conductively connected to the housing 10, and the lead portion 15 as the third conducting portion that is provided on the lower face 10D as an other face side of the housing 10, and that is conductively connected to the housing 10.

The communication connector 1 comprises the housing 10 composed of an electrically conductive material. Therefore, for example, if the ground piece 40A, as the second conducting portion, is brought into electrical contact with the enclosure 300, and the lead portion 15, as the third conducting portion, is electrically connected to the circuit board 200, the enclosure 300 and the circuit board 200 are conductively connected to each other; thus, the advantageous effect of enabling the ground potentials of the mating connector 100 and the communication connector 1 to be kept at the same ground potential as the enclosure 300 can be achieved. In addition, by forming the plurality of grounded electric current paths, the number of paths for releasing electric current that will cause noise to a portion where communication signals are not affected can be increased, and the occurrence of noise can be reduced. Therefore, the communication connector 1 has a simple structure and yet can reduce the effect of electromagnetic noise.

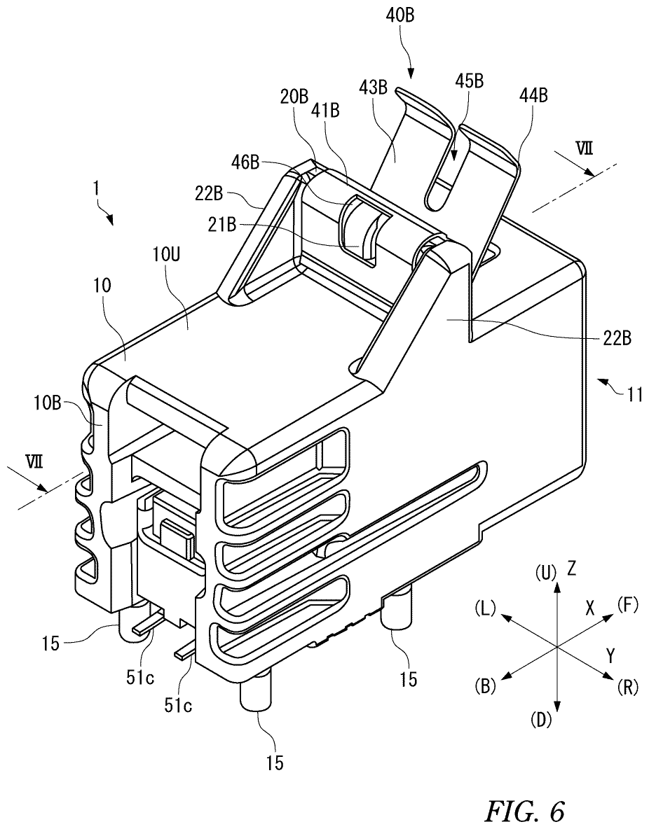

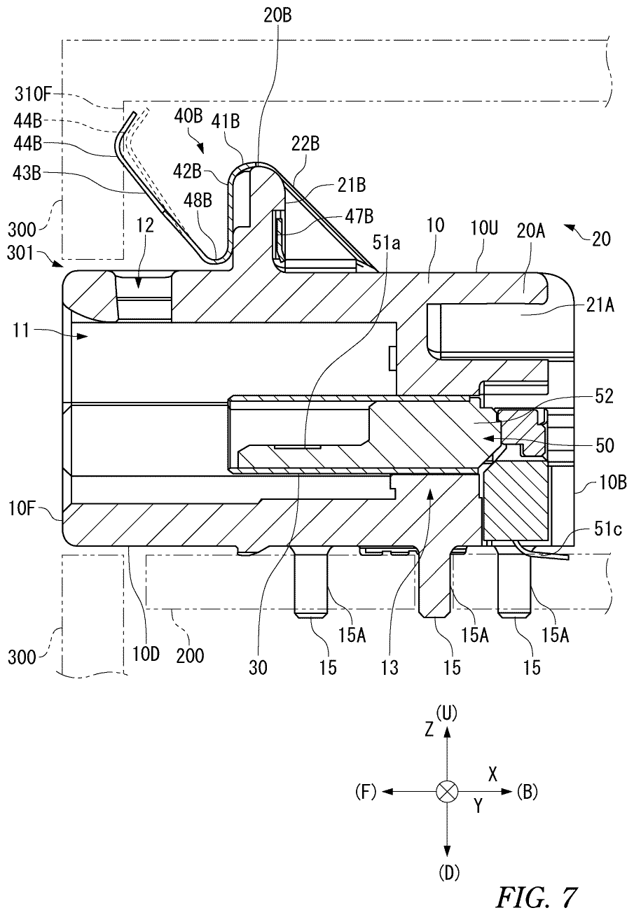

An exemplary embodiment of a communication connector 1 according to FIGS. 6-7 will now be described.

In the communication connector 1 according to FIGS. 1-5, the attachment portion 20A is formed at the rear of the housing 10, and the shielding portion 43A of the ground piece 40A is arranged in a position far from the opening portion 301, whereas the communication connector 1 according to FIGS. 6-7 is different in that an attachment portion 20B is formed at the front face 10F of the housing 10, and a shielding portion of a ground piece 40B is arranged in a position close to the opening portion 301. It should be noted that the same elements as those of the embodiment of the communication connector 1 according to FIGS. 1-5 are denoted by the same reference signs as in FIGS. 1-5 for the communication connector 1 according to FIGS. 6-7 and the descriptions thereof are omitted.

As shown in FIGS. 6-7, the attachment portion 20B is formed with triangular ribs 22B protruding in the upward direction U from the upper face 10U of the housing 10, and connecting from side faces of the housing 10 on opposite sides in the second direction Y. As shown in FIG. 6, at a middle section in the second direction Y of the attachment portion 20B, a latch portion 21B protruding from a face on the rear side is formed.

As shown in FIGS. 6-7, the attachment portion 20B is formed closer to the front face 10F than the midpoint of a length of the housing 10 in the first direction X. That is, the attachment portion 20B is formed in the housing 10 at the mating opening 11 side where the mating connector 100 is mated.

As shown in FIG. 7, the ground piece 40B, in a side view, is formed in an inverted U-shape 41B, a curved portion 48B is formed in a front section 42B of the U-shape 41B, a shielding portion 43B extending from the curved portion 48B is formed, and a curved portion 44B is formed on a distal end side of the shielding portion 43B. A rear section 47B of the U-shape 41B, as shown in FIG. 7, extends in the downward direction D, and extends obliquely downward in the rearward direction B on a distal end side.

As shown in FIG. 6, the ground piece 40B, in a top view, is formed with a notched portion 45B in the shielding portion 43B, and is divided into two branches. In addition, as shown in FIGS. 6-7, an opening 46B is formed in a middle section of the U-shape 41B, and when the ground piece 40B is attached to the attachment portion 20B, the latch portion 21B of the attachment portion 20B enters the opening 46B to prevent unexpected extraction of the ground piece 40B.

As shown in FIG. 7, the ground piece 40B is arranged at the front face 10F of the housing 10 between the housing 10 and the enclosure 300, and a portion connecting from the curved portion 48B to the shielding portion 43B and the shielding portion 43B elastically deform, thereby causing the curved portion 44B to press a wall 310F on the front side of the enclosure 300 in the first direction X. In a projected part of the ground piece 40B, when the housing 10 is viewed from the front, radiation noise entering through the opening portion 301 between the housing 10 and the enclosure 300 can be blocked in a position at the front face 10F of the housing 10. This prevents the radiation noise from entering between the communication connector 1 and the enclosure 300, thereby enabling a further reduction in the effect on the circuit board 200.

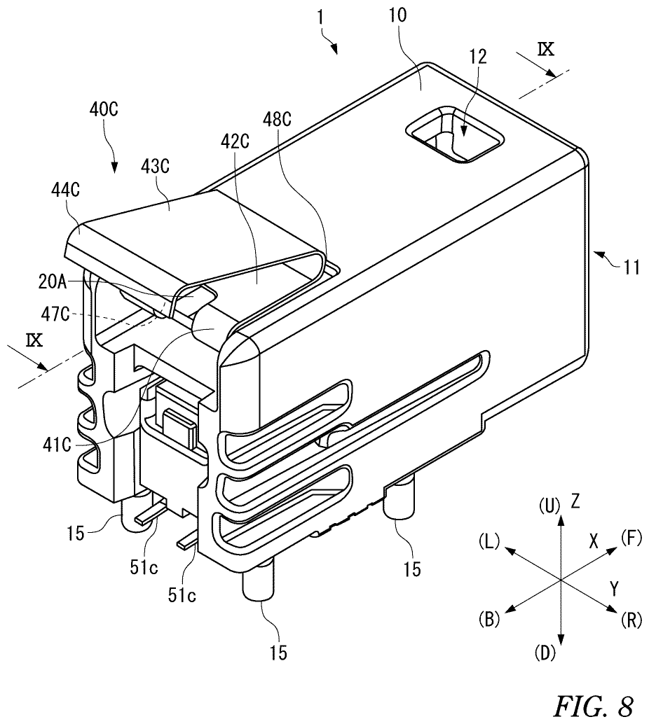

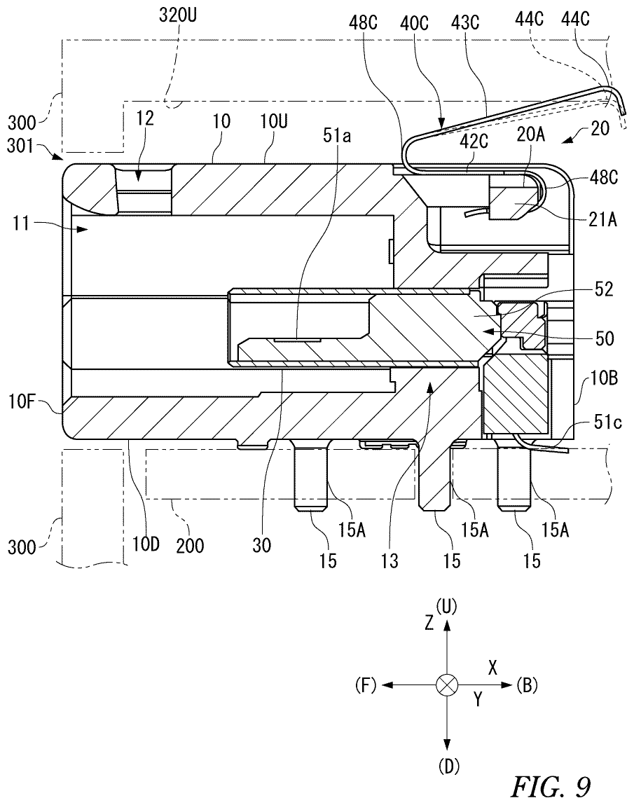

An exemplary embodiment of a communication connector 1 according to FIGS. 8-9 will now be described.

In the communication connector 1 according to FIGS. 1-5 and the communication connector 1 according to FIGS. 6-7, the shielding portion 43A of the ground piece 40A and the shielding portion 43B of the ground piece 40B are divided into two branches, whereas the communication connector 1 according to FIGS. 8-9 is different in that a shielding portion 43C of a ground piece 40C is continuous in the second direction Y. It should be noted that the same elements as those of the embodiment of the communication connector 1 according to FIGS. 1-5 are denoted by the same reference signs as in FIGS. 1-5 for the communication connector 1 according to FIGS. 8-9 and the descriptions thereof are omitted.

As shown in FIGS. 8-9, the ground piece 40C, in a side view, is formed in a U-shape 41C lying on its side at the rear, an upper section 42C of the U-shape 41C is formed, a curved portion 48C extending from the upper section 42C and folded back is formed, a shielding portion 43C extending from the curved portion 48C is formed, and a curved portion 44C is formed on a distal end side of the shielding portion 43C. A lower section 47C of the U-shape 41C, as shown in FIG. 8, extends in the frontward direction F, and extends obliquely downward in the frontward direction F on a distal end side.

As shown in FIG. 8, in the present embodiment, when the housing 10 is viewed from the front face 10F, that is, when the housing 10 is viewed in the first direction X, the projected shape of the ground piece 40C is continuous in the second direction Y. A large shielding face for shielding radiation noise entering through the opening portion 301 between the housing 10 and the enclosure 300 can be formed. In the present embodiment, the dimension in the second direction Y of the ground piece 40C is greater than the dimension in the second direction Y of the shield member 110 of the mating connector 100. By making the dimension in the second direction Y of the ground piece 40C greater than the dimension in the second direction Y of the shield member 110 of the mating connector 100, the effect of the radiation noise on the communication connector 1 and the circuit board 200 can be reduced.

As shown in FIGS. 8-9, since the shielding portion 43C of the ground piece 40C is continuous in the second direction Y, the section modulus in the thickness direction of the shielding portion 43C is greater than those of the shielding portion 43A of the ground piece 40A and the shielding portion 43B of the ground piece 40B that are divided into two branches. A pressing force onto the enclosure 300 can be secured by the shielding portion 43C of the ground piece 40C, even with a small amount of displacement of elastic deformation of the shielding portion 43C as a flat spring, and the mechanical stability of the conducting portion can be improved.

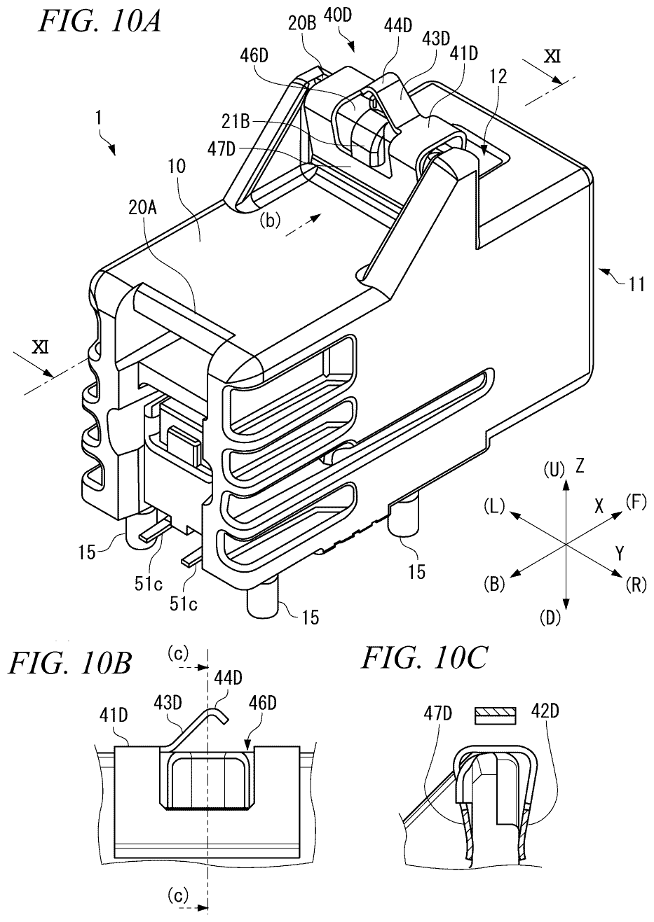

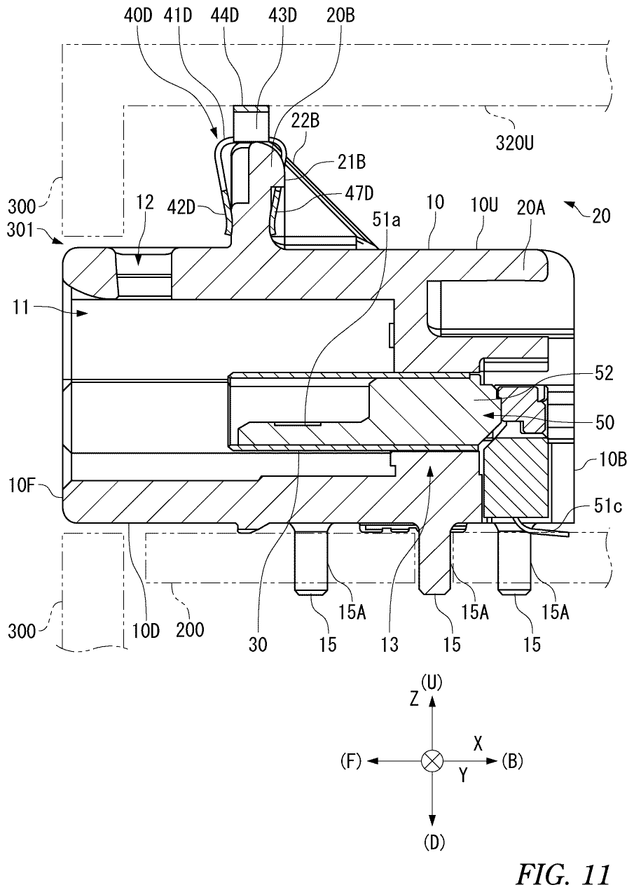

An exemplary embodiment of a communication connector 1 according to FIGS. 10A-11 will now be described.

In the communication connector 1 according to FIGS. 6-7, the attachment portion 20B is formed closer to the front face 10F than the midpoint of a length of the housing 10 in the first direction X, and the wall 310F at the front side of the enclosure 300 in the first direction X is pressed by the curved portion 44B of the ground piece 40B. In contrast, as shown in FIG. 11, the communication connector 1 according to FIGS. 10A-11 is different in that a ceiling face 320U on the upper side of the enclosure 300 in the third direction Z is pressed by a curved portion 44D of a ground piece 40D. It should be noted that the same elements as those of the embodiment of the communication connector 1 according to FIGS. 6-7 are denoted by the same reference signs as in FIGS. 1-7 for the communication connector 1 according to FIGS. 10A-11 and the descriptions thereof are omitted.

As shown in FIGS. 10A-11, the ground piece 40D, in a side view, is formed in an inverted U-shape 41D, and an upstream portion 42D and a downstream portion 47D that connect from the U-shape 41D are formed. In a front view, an extended portion 43D extending from the right toward the left and extending obliquely upward is formed, and a curved portion 44D is formed on a distal end side of the extended portion 43D.

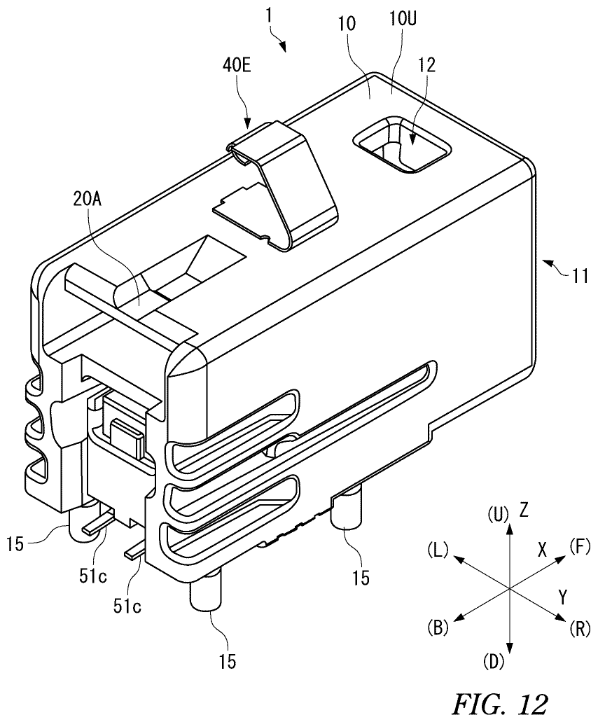

As shown in FIG. 11, in the present embodiment, the ground piece 40D is attached to the attachment portion 20B formed at the mating opening 11 side where the mating connector 100 is mated, which is the front face 10F of the housing 10. In addition, as shown in FIG. 12, the ceiling face 320U on the upper side of the enclosure 300 in the third direction Z is pressed by the curved portion 44D of the ground piece 40D. By forming a grounded electric current path at the front face 10F of the housing 10, and between the housing 10 and the ceiling face 320U, the electric current conduction distance is shortened, so that the occurrence of electromagnetic noise can be reduced.

An exemplary embodiment of a communication connector 1 according to FIG. 12 will now be described.

In all of the embodiments of the aforementioned communication connectors 1 according to FIGS. 1-11, the ground pieces 40A, 40B, 40C, 40D are attached to the attachment portions 20A, 20B, formed in the specific shapes, whereas, in the communication connector 1 according to FIG. 12 is different in that the shape for attachment of a ground piece 40E is not limited to a specific shape, but the ground piece 40E is installed on the upper face 10U of the housing 10.

As shown in FIG. 12, the ground piece 40E is installed on the upper face 10U of the housing 10. The housing 10 and the ground piece 40E are bonded and secured to each other, for example, with an electrically conductive double-sided tape or the like. In an alternative embodiment, for example, the housing 10 and the ground piece 40E are soldered to each other.

In the present embodiment, the enclosure 300 and the housing 10 can be electrically connected to each other with the ground piece 40E attached to the upper face 10U of the housing 10. Since the housing 10 is electrically conductive, the ground piece 40E can be attached in a desired position on the upper face 10U of the housing 10. By attaching the ground piece 40E in a desired position on the upper face 10U of the housing 10, an electric current path can be formed in a desired position, the degree of freedom of countermeasures against the electromagnetic noise increases, and it becomes easier to take countermeasures against the electromagnetic noise.

Without departing from the spirit of the present invention, the configurations shown and described in the various exemplary embodiments described above may be selectively adopted or eliminated, or may be appropriately modified to other configurations.

1. A communication connector, comprising:
a housing composed of an electrically conductive material and receiving a mating connector;
a first conducting portion retained in the housing and conductively connected to the housing, the first conducting portion is conductively connected to a shield member of the mating connector;
a second conducting portion provided on a side of the housing and conductively connected to the housing; and
a third conducting portion provided on another side of the housing and conductively connected to the housing.

2. The communication connector of claim 1, wherein the first conducting portion has a tubular shape and is conductively connected to the shield member on an outer peripheral face of the tubular shape, and the second conducting portion elastically deforms when conductively connected to an enclosure.

3. The communication connector of claim 1, wherein the third conducting portion is a mount portion mounting the communication connector on a circuit board.

4. The communication connector of claim 2, wherein the second conducting portion presses a wall on a front face of the housing in a first direction of the enclosure and elastically deforms when conductively connected to the enclosure.

5. The communication connector of claim 1, wherein the second conducting portion is continuous in a second direction that intersects a first direction in which the mating connector is received in the housing, and a dimension of the second conducting portion in the second direction is greater than a dimension of the shield member of the mating connector in the second direction.

6. The communication connector of claim 1, wherein the second conducting portion is formed in a U-shape.

7. The communication connector of claim 6, wherein the second conducting portion has a shielding portion extending from an upper section of the U-shape.

8. The communication connector of claim 6, wherein the U-shape has a lower section extending in a frontward direction.

9. The communication connector of claim 6, wherein the U-shape has an opening in a middle section of the U-shape.

10. The communication connector of claim 7, wherein the shielding portion has a notched portion separating the shielding portion into two sections.

11. The communication connector of claim 1, further comprising a contact molded body disposed in the first conducting portion.

12. The communication connector of claim 11, wherein the contact molded body has a contact portion that contacts a mating contact portion of the mating connector.

13. The communication connector of claim 12, wherein the contact portion has a first contact section contacting the mating contact portion, a second contact section extending perpendicularly from the first contact section, and a third contact section extending from the second contact section.

14. The communication connector of claim 13, wherein the third contact section extends out from the housing and is surface-mounted on a circuit board.

15. The communication connector of claim 1, wherein the second conducting portion is attached to an attachment portion of the housing.

16. The communication connector of claim 15, wherein a latch portion of the attachment portion enters an opening of the second conducting portion.

17. The communication connector of claim 15, wherein the attachment portion has triangular ribs protruding in an upward direction away from an upper face of the housing.

18. The communication connector of claim 1, further comprising a plurality of third conducting portions extending from a lower face of the housing.
